(19) United States
(12) Patent Application Publication
(10) Pub. No.: US 2009/0199188 A1
(43) Pub. Date: Aug. 6, 2009

(54) INFORMATION PROCESSING SYSTEM, COMPUTER READABLE RECORDING MEDIUM, INFORMATION PROCESSING DEVICE, INFORMATION PROCESSING METHOD AND COMPUTER DATA SIGNAL

(75) Inventor: Yoshihiro FUJIMAKI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/193,160

(22) Filed: Aug. 18, 2008

(30) Foreign Application Priority Data
Feb. 4, 2008 (JP) 2008-024604

(51) Int. Cl. G06F 9/46

(52) U.S. Cl. 718/101

(57) ABSTRACT

An information processing system includes: an administrator command restricting execution unit that executes an administrator command with a restriction, when a user not having administrative authority requests execution of the administrator command that can be executed by an administrator having the administrative authority: an execution history memory that stores the execution history of the administrator command executed by the administrator command restricting execution unit: and a state changing unit that, upon receipt of an acceptance of the execution history, puts the result of execution of the administrator command shown in the execution history and executed by the administrator command restricting execution unit, into the state that is observed where the administrator command shown in the execution history is executed without the restriction.

### CROSS-REFERENCE TO RELATED APPLICATION

This application is based on and claims priority under 35 USC 119 from Japanese Patent Application No. 2008-024604 filed Feb. 4, 2008.

### BACKGROUND

1. Technical Field

The present invention relates to an information processing system, a computer readable recording medium, an information processing device, an information processing method and a computer data signal.

2. Related Art

There has been a known information processing system in which a user who does not have authority performs information processing on behalf of a user who has the authority.

### SUMMARY

According to an aspect of the invention, there is provided an information processing system that includes: an administrator command restricting execution unit that executes an administrator command with a restriction, when a user not having administrative authority requests execution of the administrator command that can be executed by an administrator having the administrative authority: an execution history memory that stores the execution history of the administrator command executed by the administrator command restricting execution unit: and a state changing unit that, upon receipt of an acceptance of the execution history stored in the execution history memory from the administrator, puts the result of execution of the administrator command shown in the execution history and executed by the administrator command restricting execution unit, into the state that is observed where the administrator command shown in the execution history is executed without the restriction.

### BRIEF DESCRIPTION OF THE DRAWINGS

Exemplary embodiments of the present invention will be described in detail based on the following figures, wherein:

FIG. 1 is a functional block diagram schematically showing the structure of an information processing system in accordance with a first exemplary embodiment of the present invention;

FIG. 2 is a functional block diagram showing an example hardware structure of the information processing system;

FIG. 3 is a flowchart showing an example operation to be performed by the administrator command restricting execution device;

FIG. 4 is a flowchart showing an example operation to be performed by the authentication device;

FIG. 5 shows the memory format in the execution history memory device;

FIG. 6 is a flowchart showing an example operation to be performed by the state changing device;

FIG. 7 shows an example of an acceptance screen;

FIG. 8 is a functional block diagram schematically showing the structure of an information processing system in accordance with a second exemplary embodiment of the present invention;

FIG. 9 shows the memory format in the allowed command memory device;

FIG. 10 is a flowchart showing an example operation to be performed by the administrator command restricting execution device in accordance with the second exemplary embodiment;

FIG. 11 is a functional block diagram schematically showing the structure of an information processing system in accordance with a third exemplary embodiment of the present invention;

FIG. 12 shows the memory format in the time restriction information memory device; and

FIG. 13 is a flowchart showing an example operation to be performed by the administrator command restricting execution device in accordance with the third exemplary embodiment.

### DETAILED DESCRIPTION

### First Exemplary Embodiment

The following is a description of a first exemplary embodiment of the present invention, with reference to the accompanying drawings.

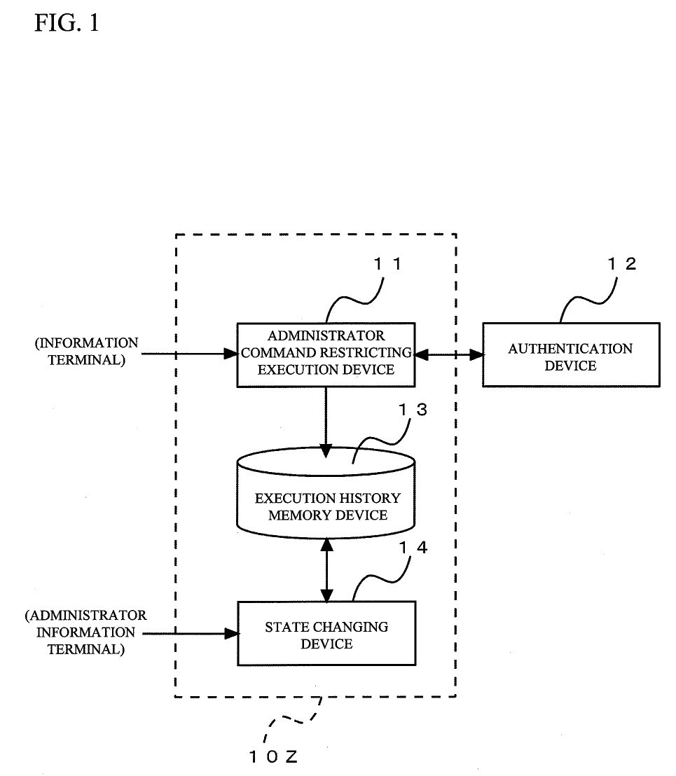

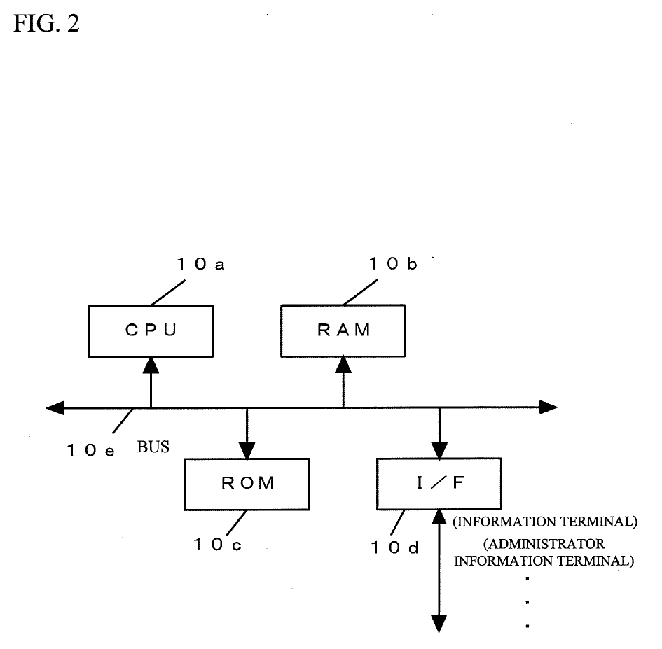

FIG. 1 illustrates the structure of an information processing system in accordance with the first exemplary embodiment of the present invention. FIG. 2 is a functional block diagram of an example hardware structure of the information processing system. Each information processing system in accordance with this exemplary embodiment and the later described other exemplary embodiments may be formed as one device covered with one housing, for example, or may be formed with two or more devices.

As shown in FIG. 1, the information processing system 10 includes an administrator command restricting execution device 11, an authentication device 12, an execution history memory device 13, and a state changing device 14. The administrator command restricting execution device 11, the execution history memory device 13, and the state changing device 14 are housed in an image processing device 10Z. The information processing device 10Z may include other devices. For example, the authentication device 12 may be housed in the information processing device 10Z. Alternatively, all the devices may be independent of one another, as shown in FIG. 1. This also applies to the later described exemplary embodiments. In any of those cases, there is not a particular restriction on the communication method utilized between the devices, and those devices can perform electric or optical communications with the use of a private line, a public line, a wireless communication technique.

The administrator command restricting execution device 11 is an example of an administrator command restricting execution unit claimed in the claims. This device receives an administrator command based on user information serving as the identification information of a user not having administrative authority, from an information terminal (not shown). If the user information is valid, the administrator command restricting execution device 11 puts a restriction on an administrator command, and then executes the administrator command. The administrator command restricting execution device 11 then stores the execution history into the execution history memory device 13, which is an example of the execution history memory claimed in the claims. In this manner, the information about the history of execution of the administrator command is stored in the execution history memory device 13.

The authentication device 12 receives authentication information that is input to the information terminal based on the user information of the user not having the administrative authority. The authentication device 12 then determines whether the user information is valid, and transmits the determination result to the administrator command restricting execution device 11.

The state changing device 14 is an example of the state changing unit claimed in the claims. The state changing device 14 receives an acceptance screen display request based on administrator information, and extracts the information about the execution history stored in the execution history memory device 13. The state changing device 14 then displays the information about the execution history as well as the acceptance screen on an administrator information terminal. Upon receipt of an acceptance about the execution history stored in the execution history memory device 13 from the administrator, the state changing device 14 puts the execution result of the execution performed by the administrator command restricting execution device 11 executing the administrator command shown in the execution history, into the state that is observed when the administrator command shown in the execution history is executed without the restriction.

The devices in the above described information processing system are realized by a computer or by a hardware structure in which a processor 10a such as a CPU, a RAM 10b such as a SRAM (Static Random Access Memory), a DRAM (Dynamic RAM), a SDRAM (Synchronous DRAM), or a NVRAM (Non-Volatile RAM), a ROM (Read Only Memory) 10c such as a flash memory, an interface 10d such as a network interface card designed to control inputs and outputs, and a hard disk or the like (not shown) are connected to one another by a bus 10e, as shown in FIG. 2.

With this structure, the CPU 10a reads a program stored in the ROM 10c or the hard disk or the like, and performs an operation in accordance with the program to realize the respective devices. Here, the program may be the program illustrated in the later described flowcharts.

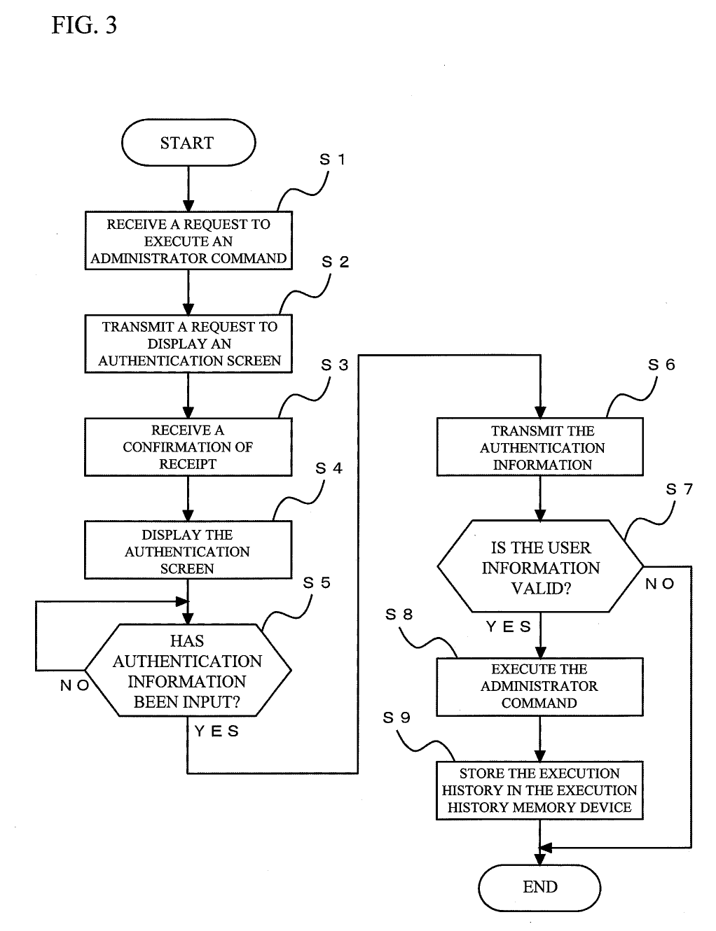

Referring now to FIGS. 3 through 7, operations to be performed in the information processing system in accordance with this exemplary embodiment are described.

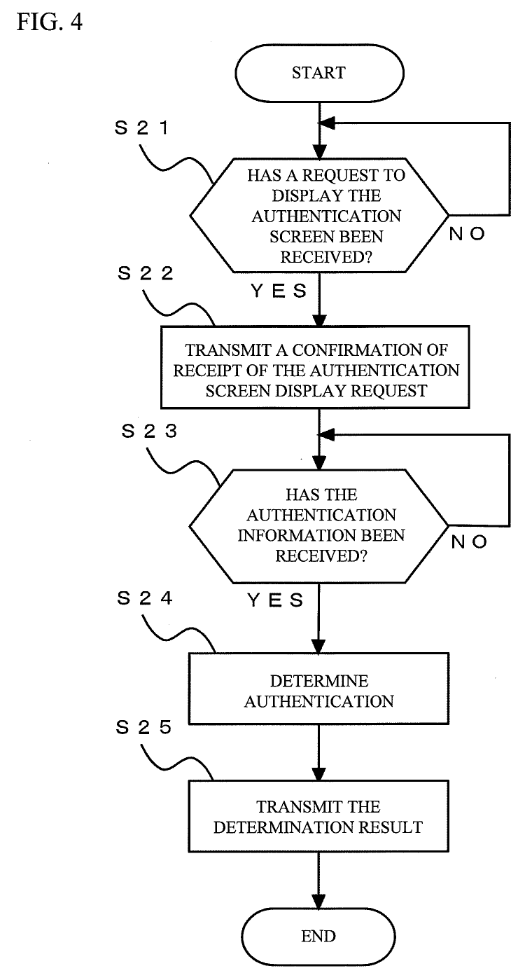

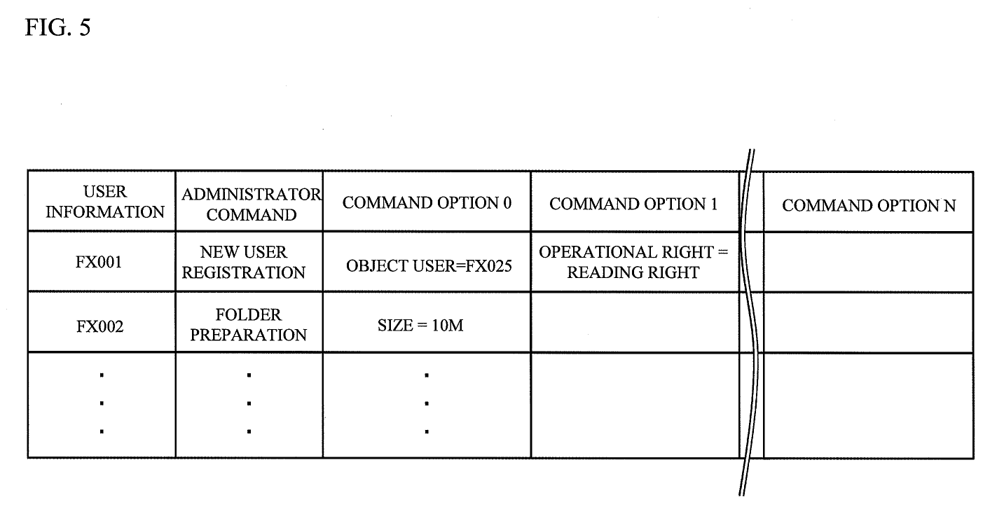

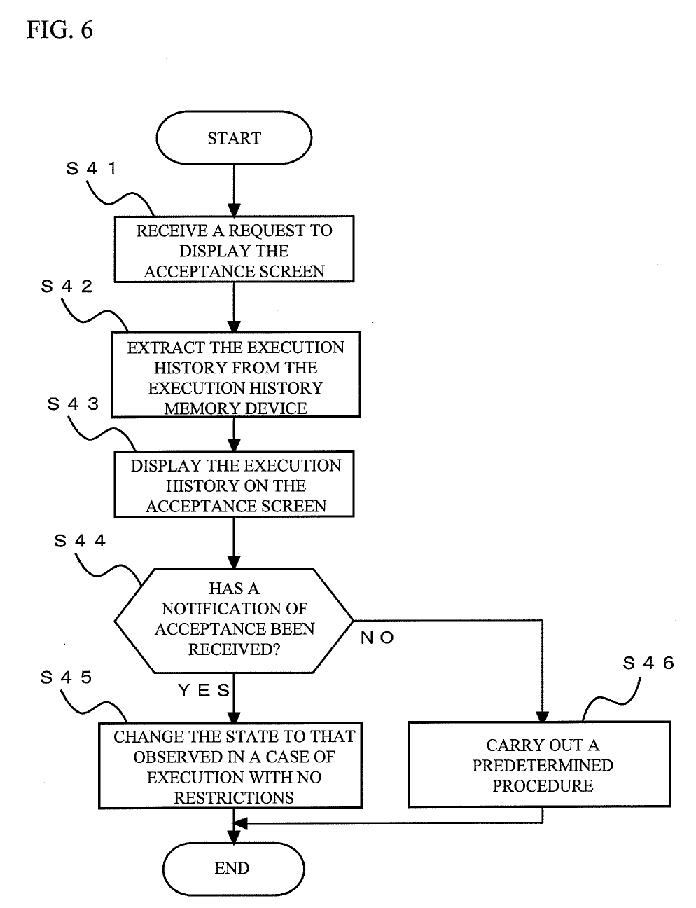

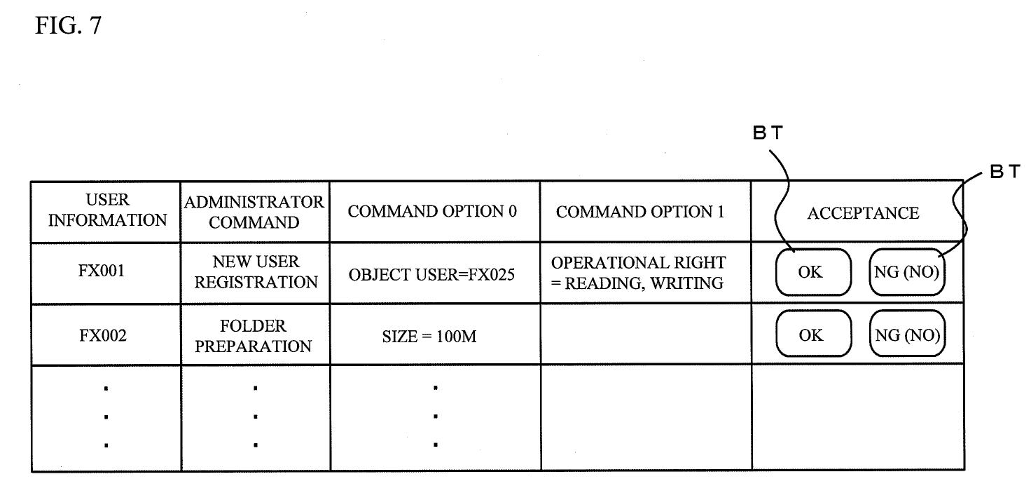

FIG. 3 is a flowchart showing an example operation to be performed by the administrator command restricting execution device 11. FIG. 4 is a flowchart showing an example operation to be performed by the authentication device 12. FIG. 5 shows the memory format in the execution history memory device 15. FIG. 6 is a flowchart showing an example operation to be performed by the state changing device 14. FIG. 7 shows an example of the acceptance screen.

First, the operation to be performed by the administrator command restricting execution device 11 is described.

As shown in FIG. 3, the administrator command restricting execution device 11 receives a request to execute an administrator command from an information terminal (step S1). The administrator command restricting execution device 11 then transmits a request to display an authentication screen to the authentication device 12 (step S2).

Upon receipt of a notification of receipt of the authentication screen display request from the authentication device 12 (step S3), the administrator command restricting execution device 11 displays the authentication screen on the information screen operated by the user (step S4).

The administrator command restricting execution device 11 is in a stand-by state until authentication information is input from the information terminal (step S5). When detecting an authentication information input, the administrator command restricting execution device 11 transmits the authentication information to the authentication device 12 (step S6). The authentication information may be in a known form, such as a user ID, a password, a pass-phrase, or biometric authentication information involving vein authentication or iris verification, for example. For example, authentication may be performed with the use of a contact-type authentication medium such as a magnetic medium or a noncontact-type authentication medium having a FRID (Radio Frequency Identification) function or the like.

Upon receipt of a notification that the authentication information is valid from the authentication device 12 (step S7), the administrator command restricting execution device 11 executes an administrator command (step S8). The administrator command restricting execution device 11 stores the execution history in the execution history memory device 13 (step S9). Here, the administrator command restricting execution device 11 puts a restriction on the execution history, and then stores the execution history. The restriction will be described later. If the notification received in step S7 indicates that the information is invalid, the administrator command restricting execution device 11 ends the execution of the administrator command, and carries out a process according to the information about operation procedures (a work flow).

Next, the operation to be performed by the authentication device 12 is described.

As shown in FIG. 4, the authentication device 12 is in a stand-by state until receiving a request for displaying an authentication screen from the administrator command restricting execution device 11 (step S21). Upon reception of the authentication screen display request, the authentication device 12 transmits a confirmation of receipt of the authentication screen display request to the administrator command restricting execution device 11 (step S22).

The authentication device 12 then enters and stays in a stand-by state until receiving authentication information from the administrator command restricting execution device 11 (step S23). Upon receipt of the authentication information, the authentication device 12 starts an authentication determining procedure (step S24). In this authentication determining procedure, the authentication device 12 determines whether the user ID and password stored beforehand in the authentication device 12 match the received authentication information. Alternatively, the authentication device 12 may inquire of a memory device provided outside the authentication device 12 about the authentication. The authentication information stored inside or outside the authentication device 12 may be set by the administrator or the like.

The authentication device 12 then transmits a determination result of step S24 to the administrator command restricting execution device (step S25). If the authentication device 12 determines that the user ID or the like matches the authentication information, for example, a determination result indicating that the authentication information is valid is transmitted. If the authentication device 12 determines that the user ID or the like does not match the authentication information, a determination result indicating that the authentication information is invalid is transmitted.

Referring now to FIG. 5, the memory format in the execution history memory device 13 is described.

The execution history is stored in the execution history memory device 13. The execution history includes the user information about users who do not have the administrative authority, executed administrator commands, and additional commands (such as the command options 0, 1, . . . , N shown in FIG. 5) accompanied by the administrator commands.

The user information is equivalent to the user ID or the like among the authentication information that is input through the information terminal. With the user information, the person who operates the information terminal is identified.

The administrator commands are commands that are executed in the information terminal, and can be executed by administrators having the administrative authority. FIG. 5 shows that the user with the user ID “FX001” has executed the administrator command “new user registration”.

The command options 0, 1, . . . , N indicate necessary information for the respective administrator commands. For example, if the administrator command is a “new user registration” command, the user ID of the new user of the information processing system and the operation authority to be given to the new user are stored as the necessary information. If the administrator command is a “folder preparation” command, the size (capacity) of a folder (storage for storing electronic documents and the likes) that can be prepared is stored as the necessary information.

As described above, in execution of an administrator command based on the user information of a user, a restriction concerning operation authorization or the like is put on the execution history. For example, the user having the user ID “FX025” can only read electronic documents and electronic drawings from the information processing system, but cannot modify or rewrite those documents and drawings.

Next, the operation to be performed by the state changing device 14 is described.

As shown in FIG. 6, upon receipt of a request for displaying an acceptance screen from the administrator information terminal (step S41), the state changing device 14 extracts the execution history from the execution history memory device 13 (step S42).

The state changing device 14 then displays the extracted execution history on the acceptance screen (step S43). As shown in FIG. 7, the contents of the execution history displayed on the acceptance screen include the user information, the administrator commands, the command options, and “OK” and “NG (NO)” buttons to be pressed to output a command indicating whether to accept those contents to the state changing device 14.

In a case where an administrator accepts the contents of execution by a user not having the administrative authority, the administrator operates the administrator information terminal to press the “OK” button with a pointer. If a case where the administrator does not accept the contents, the administrator presses the “NG (NO)” button with the pointer.

Upon receipt of a command indicating that the administrator accepts the contents (step S44), the state changing device 14 lifts the restriction on the execution history (step S45). Upon receipt of a command indicating that the administrator does not accept the contents, the state changing device 14 carries out a procedure (step S46). The procedure may involve attaching an invalid flag or the like to the execution history, for example. The lifting of the restriction may be performed by canceling the operational right of “reading” and putting the memory area into a “NULL” state not to limit the operational rights to the reading right. Alternatively, the lifting of the restriction may be performed by storing a restriction cancelled state into the information processing system by an administrator or the like, and then easing the restriction on the operational rights so as to limit the operational rights to “reading” and “writing” through a restriction canceling process.

With this arrangement, as shown in FIG. 5, in an example case where the user having the user information “FX001” but having no administrative authorities executes the administrator command “new user registration”, and the operational rights of the user information “FX025” of the user to be subjected to the process are limited to the “reading” right, the administrator command restricting execution device 11 receives an administrator command to “limit the operational rights to the reading right and the writing right” from the user having the user information “FX001”, and, according to the command, the administrator command restricting execution device 11 newly registers the user information “FX025” having the reading right and the writing right as the operational rights. The administrator command restricting execution device 11 stores the execution history into the execution history memory device 13.

The state changing device 14 is operated by the administrator through the acceptance screen, and displays the execution history on the acceptance screen, as shown in FIG. 7. When the administrator accepts the contents, the state changing device 14 changes the operational rights limited to the “reading” right to the operational rights only limited to the “reading” right and the “writing” right, and registers the new user, so that the state can be changed to a state that is observed when the command is executed without any restrictions. If the administrator does not accept the contents, the state changing device 14 leaves the operational rights limited to the “reading” right while providing an invalid flag or the like, and then ends the operation.

Also, as shown in FIG. 5, in an example case where the user having the user information “FX002” but having no administrative authorities executes the administrator command “folder preparation”, and the size of a folder that can be prepared is limited to “10 MB”, the administrator command restricting execution device 11 receives an administrator command to “create a new folder of 100 MB in capacity” from the user having the user information “FX001”, and, according to the command, the administrator command restricting execution device 11 creates a new folder of 100 MB in capacity. The administrator command restricting execution device 11 then stores the execution history into the execution history memory device 13.

When the administrator accepts the contents in the same manner as above, the state changing device 14 changes the limited folder size from “10 MB” to “100 MB”, and creates a new folder. If the administrator does not accept the contents, the state changing device 14 leaves the limited folder size at “10 MB”, and then ends the operation.

### Second Exemplary Embodiment

Next, a second exemplary embodiment of the present invention is described.

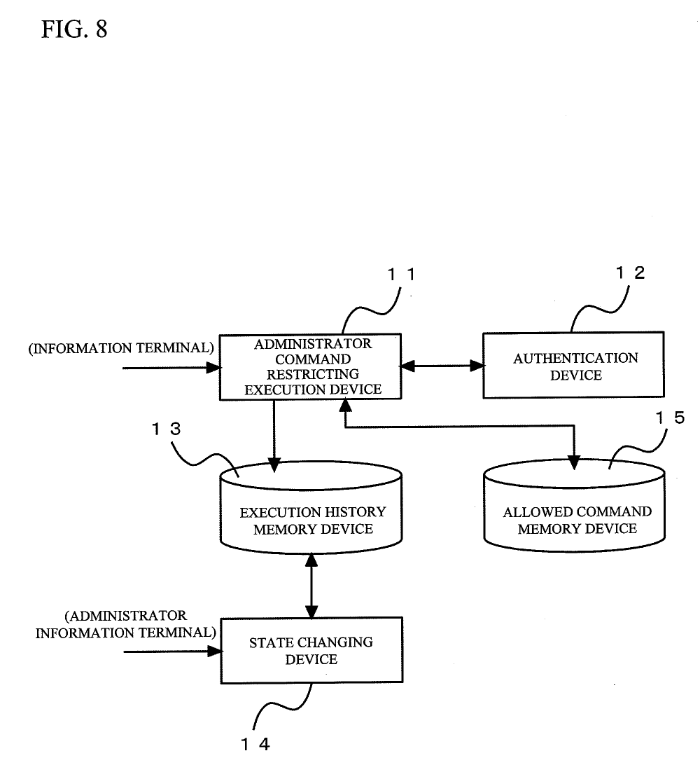

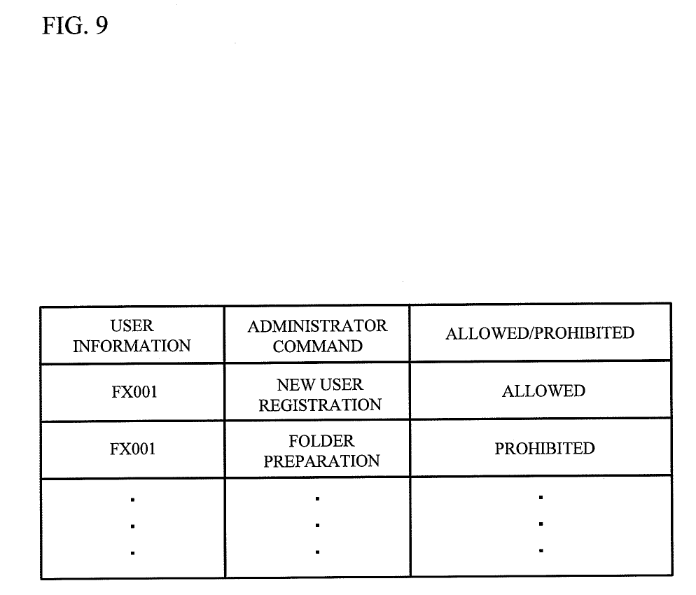

FIG. 8 is a functional block diagram schematically showing the structure of an information processing system in accordance with the second exemplary embodiment. FIG. 9 shows an example of the memory format in an allowed command memory device 15. The same components as those of the information processing system shown in FIG. 1 are denoted by the same reference numerals as those shown in FIG. 1, and explanation of them is omitted here.

The information processing system in accordance with the second exemplary embodiment differs from the information processing system in accordance with the first exemplary embodiment, in having the allowed command memory device 15 that is an example of the allowed command memory in the claims. The allowed command memory device 15 stores the user information associated with the information indicating an administrator command to put a restriction on the user information and allow execution. In other words, the allowed command memory device 15 stores allowing information to be used to determine whether an administrate command requested to execute from the information terminal is an administrator command that is allowed for the subject user information.

As shown in FIG. 9, the allowed command memory device 15 stores user information, administrator commands, and allowing/prohibiting indications, for example. The user having the user information “FX001” but not having the administrative authority is “allowed” to execute the administrator command “new user registration”, as shown in FIG. 9. Meanwhile, the user having the user information “FX002” but not having the administrative authority is “prohibited” from executing the administrator command “folder preparation”. Referring to the information stored in the allowed command memory device 15, the administrator command restricting execution device 11 determines whether to allow execution of each administrator command. It is more preferable that the determination result is transmitted to the information terminal.

Next, the operation to be performed by the administrator command restricting execution device 11 in accordance with the second exemplary embodiment is described.

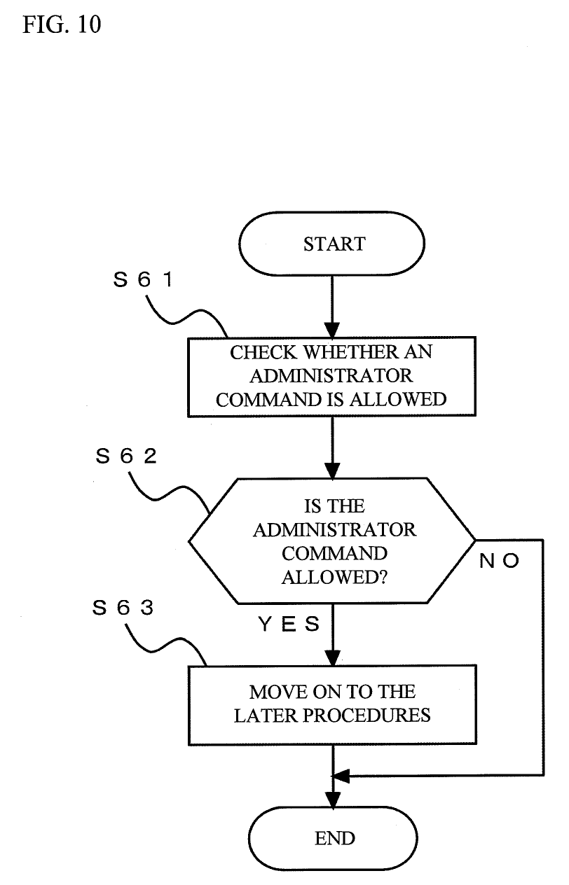

FIG. 10 is a flowchart showing an example of the operation to be performed by the administrator command restricting execution device 11 in accordance with the second exemplary embodiment. This flowchart should be inserted into the flowchart shown in FIG. 3, and more preferably, should be inserted between step S7 and step S8 of the flowchart shown in FIG. 3.

After carrying out the procedure of step S7 of FIG. 3, the administrator command restricting execution device 11 checks with the allowed command memory device 15 about whether execution of an administrator command is allowed (step S61). If the administrator command restricting execution device 11 determines that the user of the requester requesting the administrator command is allowed to execute the administrator command with the restriction (step S62), the administrator command restricting execution device 11 moves on to steps S8 and S9 of FIG. 3 (step S63). If the user is not allowed to execute the administrator command, the administrator command restricting execution device 11 ends the operation.

### Third Exemplary Embodiment

Next, a third exemplary embodiment of the present invention is described.

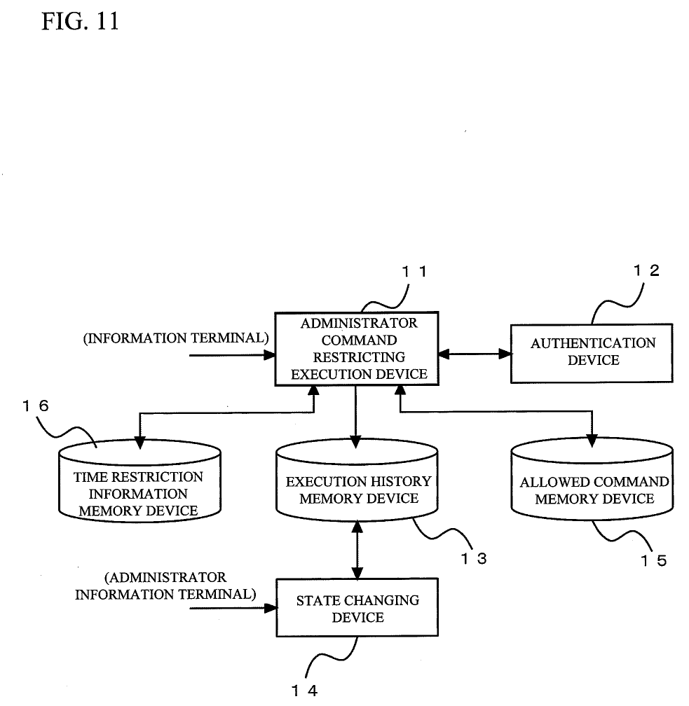

FIG. 11 is a functional block diagram schematically showing the structure of an information processing system in accordance with the third exemplary embodiment. FIG. 11 shows an example of the memory format in a time restriction information memory device 16. The same components as those of the information processing system shown in FIG. 1 are denoted by the same reference numerals as those shown in FIG. 1, and explanation of them is omitted here.

The information processing system in accordance with the third exemplary embodiment differs from the information processing system in accordance with the second exemplary embodiment, in having the time restriction information memory device 16 that is an example of the allowed command memory in the claims. This time restriction information memory device 16 stores time restriction information about execution restrictions. The time restriction information is used to determine how many times execution of an administrator command requested by the information terminal can be performed.

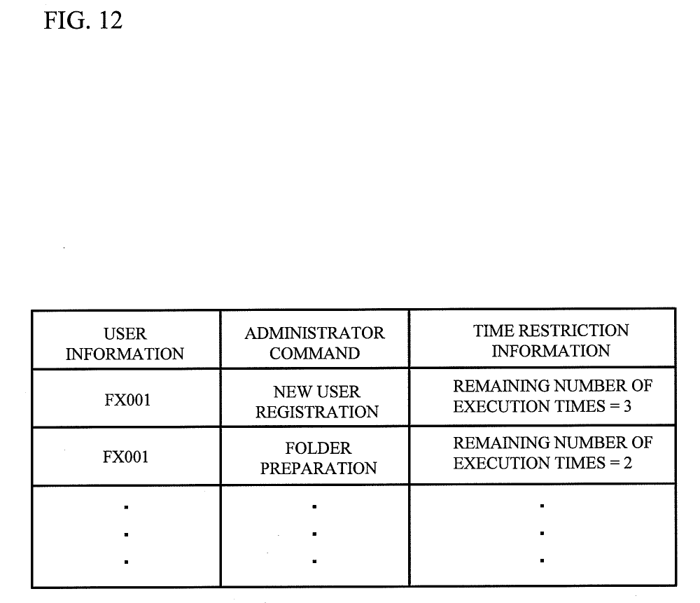

As shown in FIG. 12, the time restriction information memory device 16 stores user information, administrator commands, and restriction information about the restriction on the number of times command execution can be performed, for example. The time restriction information memory device 16 stores the user information associated with the time restriction information about the number of times an administrator command is executed by each user having the user information. As shown in FIG. 12, execution of the administrator command “new user registration” by the user having the user information “FX001” is limited to “three more execution times”. Execution of the administrator command “folder preparation” by the user having the user information “FX002” but not having the administrative authority is limited to “two more execution times”.

In the memory format for those numbers, the largest number of execution times (the number of commands) is stored, and the value of the counter that counts the number of execution times may be incremented by 1 every time an administrator command is executed. Alternatively, the remaining number of execution times is stored, and the remaining number of execution times may be reduced by 1 every time an administrator command is executed. The administrator command restricting execution device 11 checks with the time restriction information memory device 16, so as to determine the remaining number of times an administrator command can be executed.

The restriction information is not limited to the above described restriction information. For example, the restriction information may be deadline information about the date by which an administrator command can be executed. The execution deadline may be indicated in restriction information in the format of “YYYYMMDD” such as “20080331”, or may be indicated in restriction information indicating “three days later” or “one year later”, with the present date or the date registered in the information processing system serving as the reference date. Accordingly, in a case where the restriction information is stored in a deadline information memory device (not shown), an administrator command can be executed until the administrator command restricting execution device 11 determines that the date of receipt of a request is past the date indicated by the deadline information. If it is past the execution due date, a restriction is put on execution of the subject administrator command. In a case where the deadline information memory device is used, the information indicating each administrator command should be associated with the deadline information.

Next, the operation to be performed by the administrator command restricting execution device 11 in accordance with the third exemplary embodiment is described.

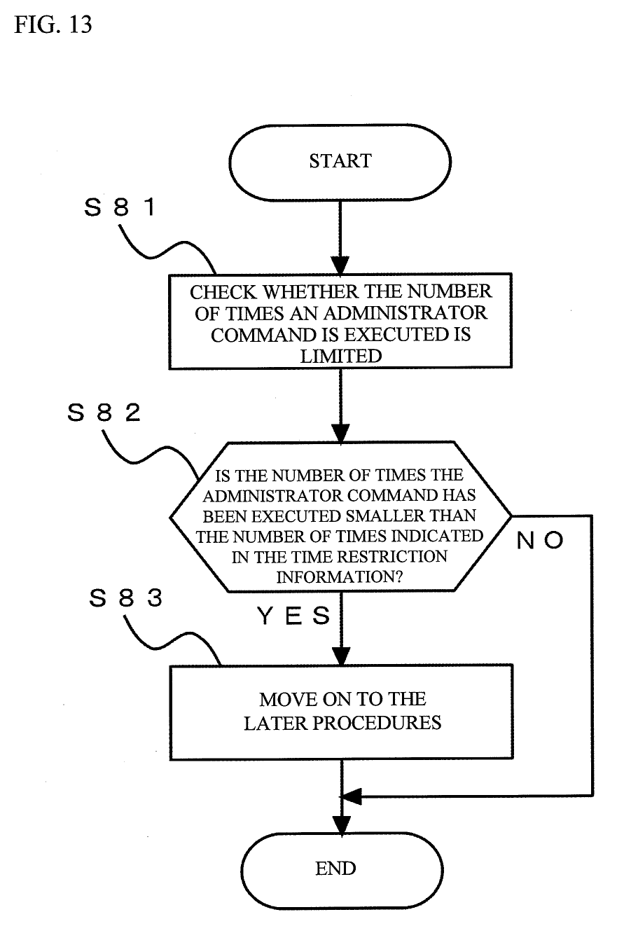

FIG. 13 is a flowchart showing an example of the operation to be performed by the administrator command restricting execution device 11 in accordance with the third exemplary embodiment. This flowchart should be inserted into the flowchart shown in FIG. 10, and more preferably, should be inserted between step S62 and step S63.

After carrying out the procedure of step S62 of FIG. 10, the administrator command restricting execution device 11 checks with the time restriction information memory device 16 about the number of execution times (step 81). If the administrator command restricting execution device 11 determines that the number of times an administrator command has been executed by the user of the requester issuing the request is smaller than the number of times indicated in the time restriction information (step S82), the administrator command restriction execution device 11 moves on to step 63 of FIG. 10 (step S83).

Although exemplary embodiments of the present invention have been described so far, the present invention is not limited to those specific examples, and various changes and modifications may be made to them without departing from the scope of the invention. For example, the program in accordance with the present invention can be of course provided through a communication unit, but it also can be recorded on a recording medium such as a CD-ROM.

The above described information terminal users who do not have the administrative authority, and the administrator information terminal may be the same information terminal or different information terminals from each other. In a case where the same information terminals shared between users without the administrative authority and administrators, the setting should be designed so that the administrators can be distinguished from the users without the administrative authority when the information terminal is used. The information terminal may be a PC (Personal Computer), a portable telephone device, a PDA (Personal Digital Assistant), or the like.

The above described administrator commands should be commands that can be executed by the administrators having the administrative authority. For example, the administrator commands may be commands issued through a command line or the Web. Further, each administrator command may include a command option suitable for the command.

The time restriction information memory device 16 may store the above described user information associated with the above described allowed information and time restriction information. If the administrator command restricting execution device 11 determines that the user of the requester requesting execution of an administrator command is allowed to execute the administrator command with a restriction, and the number of times the administrator command has been executed by the user of the requester is smaller than the number of times indicated in the time restriction information, the administrator command restricting execution device 11 may execute the requested administrator command with the restriction.

The foregoing description of the exemplary embodiments of the present invention has been provided for the purposes of illustration and description. It is not intended to be exhaustive or to limit the invention to the precise forms disclosed. Obviously, many modification and and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An information processing system comprising:
an administrator command restricting execution unit that executes an administrator command with a restriction, when a user not having administrative authority requests execution of the administrator command that can be executed by an administrator having the administrative authority:
an execution history memory that stores an execution history of the administrator command executed by the administrator command restricting execution unit: and
a state changing unit that, when receiving an acceptance of the execution history stored in the execution history memory from the administrator, puts a result of execution of the administrator command shown in the execution history and executed by the administrator command restricting execution unit, into a state that is observed where the administrator command shown in the execution history is executed without the restriction.

2. A computer readable recording medium storing a program causing a computer to execute a process for processing information, the process comprising:
executing an administrator command with a restriction, when a user not having administrative authority requests execution of the administrator command that can be executed by an administrator having the administrative authority:
storing an execution history of the administrator command executed in executing the administrator command, into an execution history memory: and
when receiving an acceptance of the execution history stored in the execution history memory from the administrator, putting a result of execution of the administrator command shown in the execution history and executed in executing the administrator command, into a state that is observed where the administrator command shown in the execution history is executed without the restriction.

3. The computer readable recording medium as claimed in claim 2, wherein the process further comprises
carrying out a procedure, upon receipt of a notification that the administrator does not accept the execution history stored in the execution history memory.

4. The computer readable recording medium as claimed in claim 2, wherein executing the administrator command with the restriction includes: referring to an allowed command memory that stores identification information of the user associated with information indicating that the user is allowed to execute the administrator command with the restriction; and executing the requested administrator command with the restriction, when a user of a requester is determined to be allowed to execute the requested administrator command with the restriction.

5. The computer readable recording medium as claimed in claim 2, wherein executing the administrator command with the restriction includes: referring to a time restriction information memory that stores identification information of the user associated with time restriction information about a restriction on the number of times the administrator command is to be executed; and executing the requested administrator command with the restriction, when the number of times the administrator command has been executed by a user of a requester is smaller than the number of times indicated in the time restriction information.

6. The computer readable recording medium as claimed in claim 5, wherein:
the time restriction information memory stores the identification information of the user associated with information indicating that the user is allowed to execute the administrator command with the restriction, and the time restriction information about the administrator command; and
executing the administrator command with the restriction includes executing the requested administrator command with the restriction, when the user of the requester is determined to be allowed to execute the requested administrator command with the restriction, and the number of times the administrator command has been executed by the user of the requester is smaller than the number of times indicated in the time restriction information.

7. The computer readable recording medium as claimed in claim 2, wherein executing the administrator command with the restriction includes: referring to a deadline information memory that stores information indicating the administrator command associated with deadline information about a deadline before which the administrator command can be executed; and executing the requested administrator command with the restriction, when the date of receipt of the request is earlier than the date indicated in the deadline information associated with the information indicating the administrator command.

8. An information processing device comprising:
an administrator command restricting execution unit that executes an administrator command with a restriction, when a user not having administrative authority requests execution of the administrator command that can be executed by an administrator having the administrative authority:
an execution history memory that stores an execution history of the administrator command executed by the administrator command restricting execution unit: and
a state changing unit that, when receiving an acceptance of the execution history stored in the execution history memory from the administrator, puts a result of execution of the administrator command shown in the execution history and executed by the administrator command restricting execution unit, into a state that is observed where the administrator command shown in the execution history is executed without the restriction.

9. An information processing method comprising:
executing an administrator command with a restriction, when a user not having administrative authority requests execution of the administrator command that can be executed by an administrator having the administrative authority:
storing an execution history of the administrator command executed in executing the administrator command, into an execution history memory: and
when receiving an acceptance of the execution history stored in the execution history memory from the administrator, putting a result of execution of the administrator command shown in the execution history and executed in executing the administrator command, into a state that is observed where the administrator command shown in the execution history is executed without the restriction.

10. A computer data signal causing a computer to execute a process for processing information, the process comprising:
executing an administrator command with a restriction, when a user not having administrative authority requests execution of the administrator command that can be executed by an administrator having the administrative authority:
storing an execution history of the administrator command executed in executing the administrator command, into an execution history memory: and
when receiving an acceptance of the execution history stored in the execution history memory from the administrator, putting a result of execution of the administrator command shown in the execution history and executed in executing the administrator command, into a state that is observed where the administrator command shown in the execution history is executed without the restriction.
